(19) United States
(12) Patent Application Publication
(10) Pub. No.: US 2010/0106910 A1
(43) Pub. Date: Apr. 29, 2010

(54) CACHE MEMORY AND METHOD OF CONTROLLING THE SAME

(75) Inventor: Hideyuki MIWA, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki (JP)

(21) Appl. No.: 12/603,273

(22) Filed: Oct. 21, 2009

(30) Foreign Application Priority Data
Oct. 27, 2008 (JP) 2008-275422

(51) Int. Cl. G06F 12/08; G06F 12/00

(52) U.S. Cl. 711/118; 711/E12.001; 711/E12.017

(57) ABSTRACT

It is an object of the present invention to reduce output of a WAIT signal to maintain data consistency to effectively process subsequent memory access when there is no subsequent memory access in case of miss hit in a cache memory having a multi-stage pipeline structure. A cache memory according to the present invention performs update processing of a tag memory and a data memory and decides whether or not there is a subsequent memory access upon decision by a hit decision unit that an input address is a miss hit. Upon decision that there is a subsequent memory access, a controller outputs a WAIT signal to generate a pipeline stall for the pipeline processing of the processor to the processor, while the controller does not output a WAIT signal upon decision that there is no subsequent memory access.

### BACKGROUND

1. Field of the Invention

The present invention relates to a cache memory that processes a memory access from a processor by a pipeline which is divided into a plurality of process stages and a method of controlling the same.

2. Description of Related Art

A cache memory that uses a clock synchronous SRAM (synchronous SRAM) and adopts a pipeline structure has been put to practical use.

A cache memory having such a pipeline structure is arranged between a processor and a low-speed memory and processes a memory access request from the processor by the pipeline which is divided into a plurality of process stages (see Japanese Unexamined Patent Application Publication No. 10-63575 (patent document 1), for example). The processor that performs a memory access request to the cache memory having the pipeline structure is typically a RISC (Reduced Instruction Set Computer) type microprocessor. The processor may be a CISC (Complex Instruction Set Computer) type or may be a DSP (Digital Signal Processor) for performing a digital signal processing such as a speech processing or an image processing. When the cache memory having the pipeline structure is used in a second cache or in a cache which has a lower order, a higher order cache memory corresponds to the processor that performs a memory access request to the cache memory.

It can be expected that throughput is improved by increasing the number of pipeline stages of the cache memory. On the other hand, cache access time, which is the time required to get a result after the processor gives the access request to the cache memory, is increased. The number of pipeline stages of the cache memory is typically two because the increase of the cache access time is undesirable.

On the other hand, especially in a set associative type cache memory, another configuration is also known for reading out of data by accessing only a way that is hit in response to a load request instead of reading out of the data from all the ways of the data memory for the purpose of reducing power consumption of the cache memory.

A configuration example of the related cache memory having a two-stage pipeline structure is shown in FIG. 8. A cache memory 8 shown in FIG. 8 is a four-way set associative type cache memory and is arranged between a processor 2 and a main memory 3 which is a low-speed memory. The cache memory 8 and the processor 2 are connected by an address bus 4, a data bus 5, and a WAIT signal line 7. Further, the cache memory 8 and the main memory 3 are connected by a memory bus 6.

A data memory 10 included in the cache memory 8 is configured to store the data corresponding to a subset of the data stored in the main memory 3. A storage area of the data memory 10 is physically or logically divided into four ways. Furthermore, each way is managed by a data storage unit which is a multiple word unit called line. A place where the data is stored in the data memory 10 is designated by decoding a lower part of an input address which is supplied from the address bus 4. More specifically, the line is designated by an index address which is a higher order part of the lower part of the input address and a word position in the line is designated by a word address which is the lowest part of the input address. An example of the input address is shown in FIG. 10. Each bit number of the above-described word address, the index address, and a tag address which is arranged higher than the word address and the index address is decided depending on how the number of ways of the cache memory 8, the number of lines included in one way, and the number of words included in one line are designed.

A tag memory 11 is configured to store the tag address corresponding to the data stored in line in the data memory 10. The tag memory 11 receives the index address included in the input address and outputs the tag address identified by decoding the index address. The cache memory 8 shown in FIG. 8 is the four-way type cache memory and outputs four tag addresses corresponding to the four ways in response to one index address which is input. The tag memory 11 has a valid flag (not shown) showing a validity of the stored tag address and a dirty flag (not shown) showing that there is a mismatch between the data stored in the data memory 10 and the data stored in the main memory 3 due to the data memory 10 being updated by the store access.

A hit decision unit 12 makes a decision whether there is a cache hit or a miss hit by comparing the tag address included in the input address with four tag addresses output from the tag memory 11. More specifically, the hit decision unit 12 outputs a signal indicating the cache hit when the tag address included in the input address and the output of the tag memory 11 are matched, and outputs a signal indicating the cache miss when they are not matched. The output signal of the hit decision unit 12 is a four-bit signal in total indicating a hit decision result for one way in one-bit logical value respectively. Further, the output signal from the hit decision unit 12 is input to a controller 83 through a hit decision signal line 22.

The controller 83 controls reading out of the data from the data memory 10 by outputting a chip select signal (CS signal) and a read strobe signal (RS signal) to the data memory 10 when a hit decision result by the hit decision unit 12 is the cache hit. On the other hand, when the hit decision result by the hit decision unit 12 is the miss hit, the controller 83 controls rewriting of the tag memory 11 in order to store the tag address included in the input address in the tag memory 11 and controls data refilling of the data memory 10. The control of the data refilling means the controls of reading out of the data from the main memory 3 and rewriting of the data memory 10 by the data read out from the main memory 3. The controller 83 outputs a WAIT signal using the WAIT signal line 7 to notify the processor 2 of the miss hit.

An address latch 14 is a circuit for holding at least the tag address part of the input address for one clock cycle. For example, the address latch 14 can be composed of D flip-flops. The data stored in the address latch 14 is used as data input to the tag memory 11 when the tag memory 11 is rewritten.

Referring now to FIG. 9, a behavior of the cache memory 8 is described. FIG. 9 shows a pipeline behavior of the cache memory 8 when a load request made by the processor 2 is processed. Part (a) of FIG. 9 shows the behavior when the hit decision result is the cache hit and part (b) of FIG. 9 shows the behavior when the hit decision result is the miss hit. In a first stage of the pipeline, the tag memory 11 receives the input address supplied from the processor 2 and outputs four tag addresses corresponding to the index address of the input address. Also in the same first stage, the hit decision unit 12 performs the hit decision.

When the decision result made by the hit decision unit 12 is the cache hit, the input address, the CS signal, and the RS signal are input to the data memory 10 at a last part of the first stage. As shown in the part (a) of FIG. 9, in a second stage just after the first stage, the data is read out from the data memory 10 and output to the processor 2. The data output from the cache memory 8 is stored in a storage area of the processor 2 such as a general register.

On the other hand, when the decision result made by the hit decision unit 12 is the miss hit, the controller does not output the CS signal and the RS signal at the last part of the first stage. Then as shown in the part (b) of FIG. 9, in the second stage that follows the first stage, the controller 83 performs a process of deciding a replacement way and an update process of the tag address corresponding to the line decided as the replacement way held in the tag memory 11 with a new tag address included in the input address. In the same second stage, the controller 83 performs a read access to the main memory 3 connected through the memory bus 6, and the data corresponding to the input address is read out from the main memory 3 and stored in the data memory 10. Also in the same second stage, the data read out from the main memory 3 is output to the processor 2.

On the other hand, Japanese Unexamined Patent Application Publication No. 2008-107983 (patent document 2) discloses a technique regarding a cache memory for improving the operating frequency of the related cache memory 8 as shown in FIG. 8. A cache memory according to the patent document 2 divides hit decision processing and tag address reading processing from a tag memory into different pipeline stages, and in case of the miss hit, performs an update processing of the tag memory and inputs the tag address to the hit decision unit by bypassing the tag memory. FIG. 11 is a configuration diagram of a cache memory 8a according to the patent document 2. The outline of the operation of the cache memory 8a will be described below with reference to FIG. 11. The cache memory 8a reads out a tag address from the tag memory 11 at a first stage. Then, at a second stage, the cache memory 8a performs hit decision by the hit decision unit 12. When the hit decision result is the cache hit, the cache memory 8a reads out data from the data memory 10 at a third stage or later. Subsequently, the cache memory 8a outputs the data which is read out from the data memory 10 to the processor 2. On the other hand, when the hit decision result is the miss hit, the cache memory 8a executes the following processing at a third stage. First, the cache memory 8a controls updating of the tag memory 11 by a controller 83a. Then, the cache memory 8a executes control of a selector 19 to input the data held in the address latch 17 to the hit decision unit 12 by bypassing the tag memory 11. Further, a WAIT signal to stall the pipeline processing of the cache memory 8a and to stall the pipeline processing of the processor 2 is output to the processor 2. After that, at a fourth stage or later, the cache memory 8a updates the data memory 10 with the data read out from the main memory 3, and outputs the data read out from the main memory 3 to the processor 2.

### SUMMARY

However, the present inventors have found that the processing in case of the miss hit of the patent document 2 may be improved. That is, according to the patent document 2, the WAIT signal is always output to the processor in case of the miss hit regardless of whether there is a subsequent memory access or not.

It is effective to stall the pipeline processing of the cache memory and to output the WAIT signal in case of the miss hit in order to maintain data consistency between the main memory and the cache memory when the subsequent memory access request corresponds to an access to the same memory block as the preceding memory access request in which the miss hit occurs. This is because, if the miss hit occurs in one memory access request and the tag memory is updated, and then it is possible to reflect the update result of the tag memory due to the occurrence of the miss hit in the preceding memory access request on the hit decision in the subsequent memory access request.

However, it is not always effective to stall the pipeline processing of the cache memory to output the WAIT signal when there is no subsequent memory access even when the miss hit occurs in one memory access request and updating of the tag memory is performed. For example, when the subsequent memory access request corresponds to an access to a memory block which is different from the previous memory access request in which the miss hit occurs, there is no problem such that unnecessary data refilling is performed even when the pipeline processing of the cache memory is not stalled and the WAIT signal is not output. Otherwise, when the subsequent processing is not the load instruction or the store instruction, there is no problem such that it is falsely decided as cache hit instead of miss hit and false data is read out. As such, it is sometimes the case that the update result of the tag memory due to the occurrence of the miss hit in the preceding memory access request needs not be reflected on the subsequent memory access request.

A first exemplary aspect of an embodiment of the present invention is a cache memory arranged between a processor and a low-speed memory and performing a pipeline processing of a memory access made by the processor. The cache memory includes a data memory, a tag memory, a hit decision unit, and a controller. The data memory stores data corresponding to a subset of the low-speed memory. The tag memory stores tag addresses corresponding to the data stored in the data memory. The hit decision unit decides whether there is a cache hit or a miss hit by comparing at least one tag address acquired by searching the tag memory using a first index address included in an input address supplied from the processor with a tag address included in the input address. The controller performs update processing of the tag memory and the data memory and decides whether or not there is a subsequent memory access upon decision by the hit decision unit that the input address is the miss hit. The controller outputs a WAIT signal for generating a pipeline stall for the pipeline processing of the processor to the processor upon decision that there is the subsequent memory access. The controller does not output the WAIT signal upon decision that there is no subsequent memory access.

A second exemplary aspect of an embodiment of the present invention is a method of controlling a cache memory arranged between a processor and a low-speed memory and performing a pipeline processing of a memory access made by the processor. The cache memory includes a data memory, a tag memory, a hit decision unit, and a controller. The data memory stores data corresponding to a subset of the low-speed memory. The tag memory stores tag addresses corresponding to the data stored in the data memory.

The method includes searching one tag address from the tag memory using a first index address included in an input address supplied from the processor. The method further includes deciding whether there is a cache hit or a miss hit by comparing at least one tag address acquired by searching the tag memory with a tag address included in the input address. The method further includes updating the tag memory and the data memory upon decision that the input address is the miss hit. The method further includes deciding whether there is a subsequent memory access upon decision as the miss hit, and outputting a WAIT signal for generating a pipeline stall for the pipeline processing of the processor to the processor upon decision that there is the subsequent memory access, while not outputting the WAIT signal upon decision that there is no subsequent memory access.

According to the cache memory and the method of controlling the same of the present invention as stated above, the output of the WAIT signal is controlled in accordance with the subsequent memory access in case of the miss hit. Accordingly, the pipeline processing of the processor is not stalled when the subsequent memory access does not influence the update processing of the data memory of the previous memory access, which enables to proceed the subsequent processing without delay.

According to the present invention, it is possible to provide a cache memory that enables to reduce the output of the WAIT signal to maintain the data consistency and to effectively process the successive memory accesses when there is no subsequent memory access in case of the miss hit, and a method of controlling the same.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a configuration diagram of a cache memory according to a first exemplary embodiment of the present invention;

FIG. 2 is a flow chart showing a WAIT signal output control processing in case of miss hit according to the first exemplary embodiment of the present invention;

FIG. 3 is a diagram showing a pipeline processing made by the cache memory according to the first exemplary embodiment of the present invention;

FIG. 4 is a configuration diagram of a cache memory according to a second exemplary embodiment of the present invention;

FIG. 5 is a flow chart showing a WAIT signal output control processing in case of miss hit according to the second exemplary embodiment of the present invention;

FIG. 6 is a diagram showing a pipeline processing made by the cache memory according to the second exemplary embodiment of the present invention;

FIG. 7 is a diagram showing a timing chart of the cache memory according to the second exemplary embodiment of the present invention;

FIG. 8 is a configuration diagram of a cache memory according to a prior art;

FIG. 9 is a diagram showing pipeline processing made by the cache memory according to the prior art;

FIG. 10 is a diagram showing the configuration of an input address; and

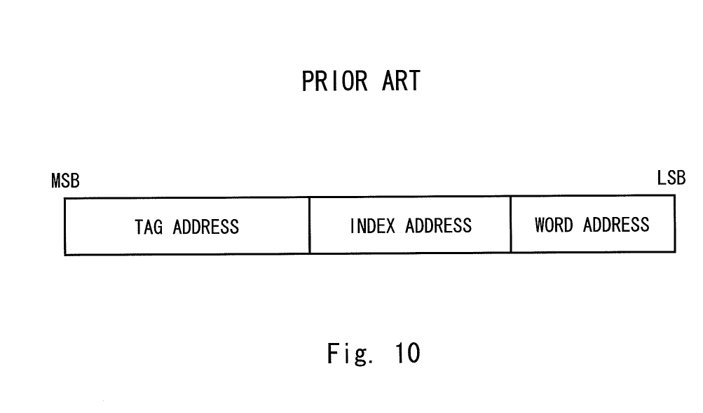

FIG. 11 is a configuration diagram of the cache memory according to the prior art.

### DETAILED DESCRIPTION OF THE EXEMPLARY EMBODIMENTS

The specific embodiments to which the present invention is applied will now be described in detail below with reference to the drawings. Throughout the drawings, the same components are denoted by the same reference symbols, and the overlapping description is omitted as appropriate for the sake of clarity.

### FIRST EXEMPLARY EMBODIMENT

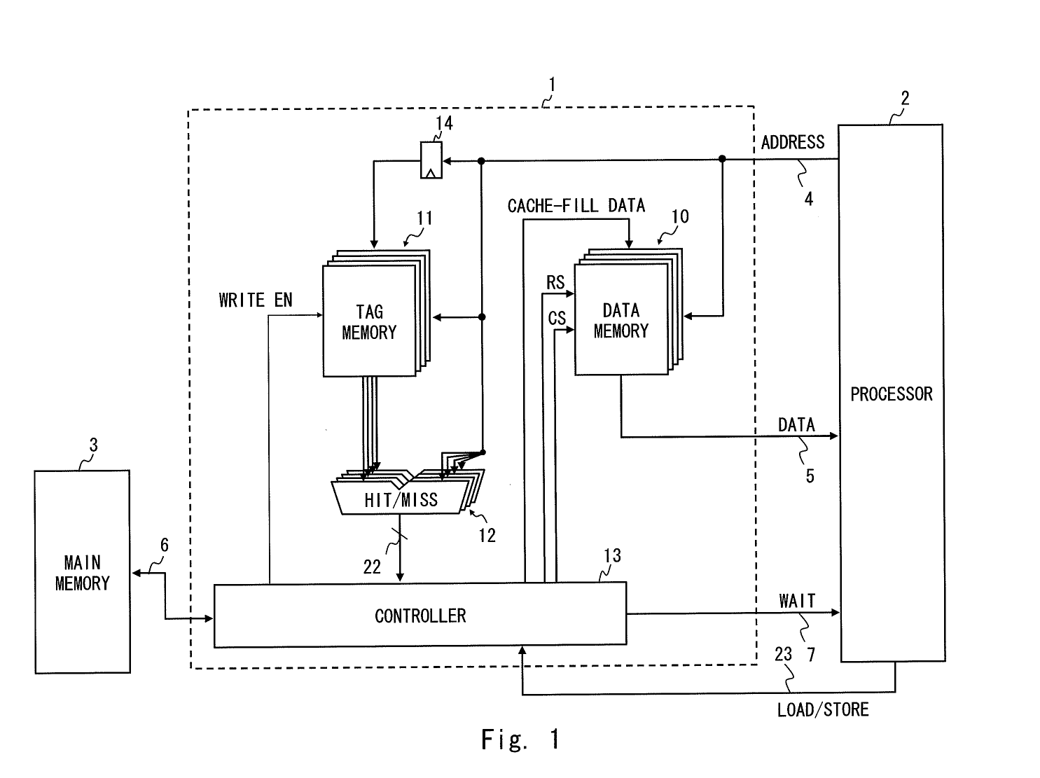

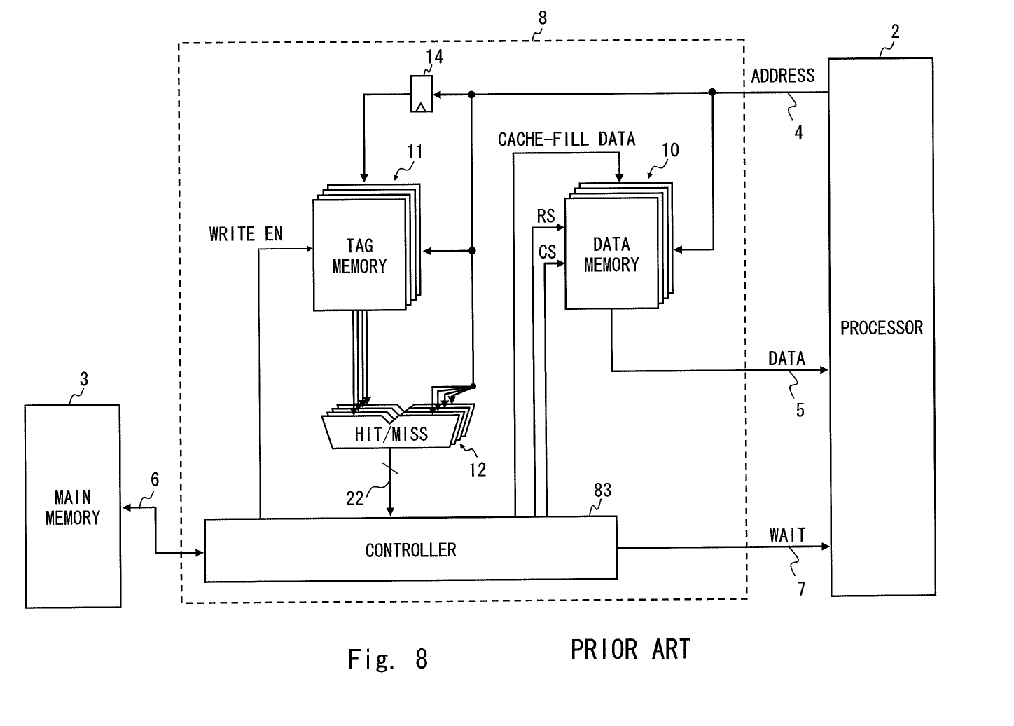

FIG. 1 is a configuration diagram of a cache memory according to the first exemplary embodiment of the present invention. A cache memory 1 according to the first exemplary embodiment of the present invention is a four-way set associative type cache memory. We assume that the cache memory here is the four-way set associative configuration so that the cache memory 1 and a cache memory 8 of a prior art shown in FIG. 8 are easily compared. However, such a configuration is merely one example. The number of ways of the cache memory 1 may be other than four or the cache memory 1 may be a direct-map type cache memory.

The components of a data memory 10, a tag memory 11, a hit decision unit 12, and a data latch 14, all of which being included in the cache memory 1, is the same as the components shown in FIG. 8. Therefore, the same components are denoted by the same reference symbols and detailed description will be omitted here.

The cache memory 1 is arranged between a processor 2 and a main memory 3 which is a low-speed memory, and processes a memory access request from the processor 2 by the pipeline. Further, the cache memory 1 and the processor 2 are connected by a control signal line 23 in addition to an address bus 4, a data bus 5, and a WAIT signal line 7. The processor 2 inputs a control signal including a flag indicating a store instruction and a flag indicating a load instruction in the memory access to the controller 13 through the control signal line 23. A control signal in one memory access is input substantially at the same timing as the input address in the memory access input through the address bus 4.

The behavior of the controller 13 included in the cache memory 1 in case of cache hit is similar to that of a controller 83 of the prior art. In summary, the controller 13 outputs a chip select signal (CS signal) and a read strobe signal (RS signal) to the data memory 10 to control the data reading from the data memory 10 when it is decided as the cache hit by the hit decision unit 12.

Further, when it is decided as the miss hit by the hit decision unit 12, the controller 13 controls the tag memory update processing, data memory update processing, and the output processing. In the tag memory update processing, the tag address held in the tag memory 11 is updated with the tag address included in the input address. In the data memory update processing, the data is read out from the main memory 3, and the data memory 10 is updated with this data. In the output processing, the data which is read out is output to the processor 2.

Further, when it is decided as the miss hit by the hit decision unit 12, the controller 13 decides whether there is a subsequent memory access. Then, the controller 13 executes a processing to generate a pipeline stall and a WAIT output control processing.

The processing to generate the pipeline stall is a processing to generate a pipeline stall of at least one clock cycle for the pipeline processing of the cache memory 1 upon decision that there is a subsequent memory access. The WAIT output control processing is a processing of outputting the WAIT signal to generate the pipeline stall for the pipeline processing of the processor 2 to the processor 2.

Further, the controller 13 does not execute the WAIT output control processing when it is decided that there is no subsequent memory access.

Accordingly, the cache memory 1 is able to stall the pipeline processing of the cache memory 1 when it is decided as the miss hit in one memory access and there is a subsequent memory access. At this time, the cache memory 1 is able to output the WAIT signal to stall the pipeline processing of the processor 2. At this time, the cache memory 1 is able to prevent unnecessary data refilling processing or false data reading and to perform appropriate processing in the subsequent memory access processing. Further, when it is decided as the miss hit in one memory access and there is no subsequent memory access, the cache memory 1 does not stall the pipeline processing of the cache memory 1 and the processor 2, whereby the processing can be performed without undesired delay in the processing of the subsequent memory access.

Now, upon decision as the miss hit, the controller 13 refers to the flag included in the control signal that corresponds to the next memory access of the memory access in which decision is made as the miss hit that is input through the control signal line 23, and checks whether or not the flag is valid. When the flag is valid, which means when the next memory access is one of the load instruction and the store instruction, the controller 13 decides that there is a subsequent memory access. On the other hand, when the flag is invalid, which means when the next memory access is neither the load instruction nor the store instruction, the controller 13 decides that there is no subsequent memory access. Accordingly, it can be easily decided whether there is a subsequent memory access.

When there is a subsequent memory access, the controller 13 outputs the WAIT signal to the processor 2. Further, when there is no subsequent memory access, the controller 13 does not output the WAIT signal. Accordingly, the subsequent processing can be advanced without delay when there is no load or store request to the memory.

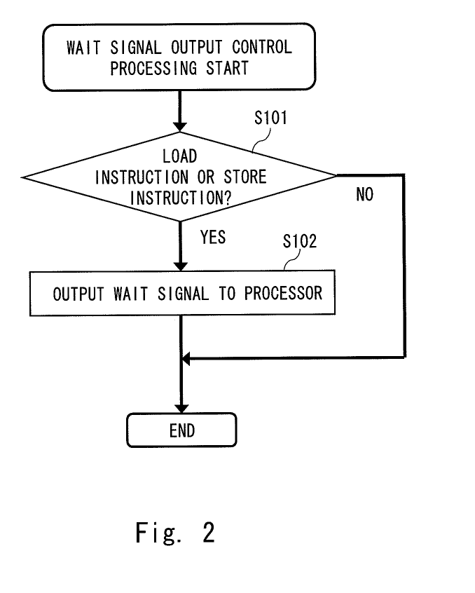

FIG. 2 is a flow chart showing a WAIT signal output control processing in case of the miss hit according to the first exemplary embodiment of the present invention. First, in case of the miss hit, the controller 13 decides whether there is a subsequent memory access by deciding if the next memory access is one of the load instruction and the store instruction by referring to the flag included in the control signal that corresponds to the next memory access of the memory access in which it is decided as the miss hit (S101).

When the next memory access is one of the load instruction and the stores instruction, the controller 13 stalls the pipeline processing of the cache memory 1, and outputs the WAIT signal to the processor 2 (S102). Accordingly, after that, the pipeline processing of the cache memory 1 and the processor 2 is stalled, and the processing for the subsequent memory access is executed for the tag memory 11 after being updated.

When it is decided in step S101 that the next memory access is neither the load instruction nor the store instruction, the controller 13 does not stall the pipeline processing of the cache memory 1, and does not output the WAIT signal to the processor 2. As such, after that, the processing for the subsequent memory access is subsequently performed without waiting for the updating of the tag memory 11.

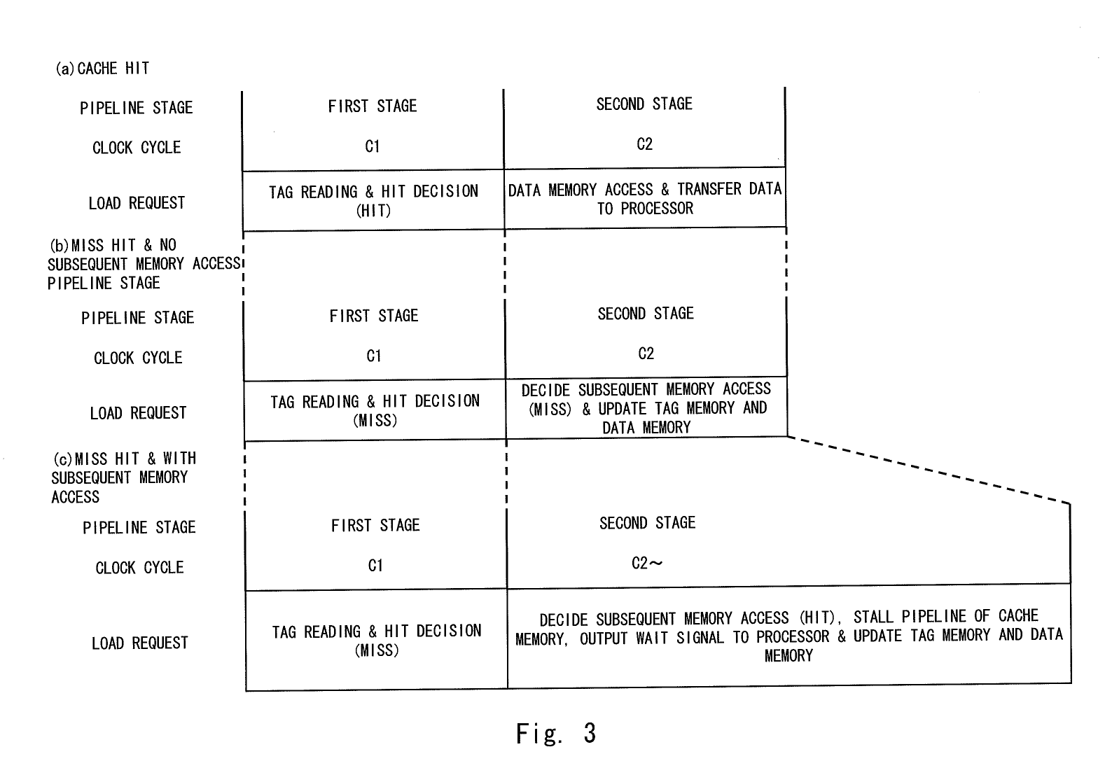

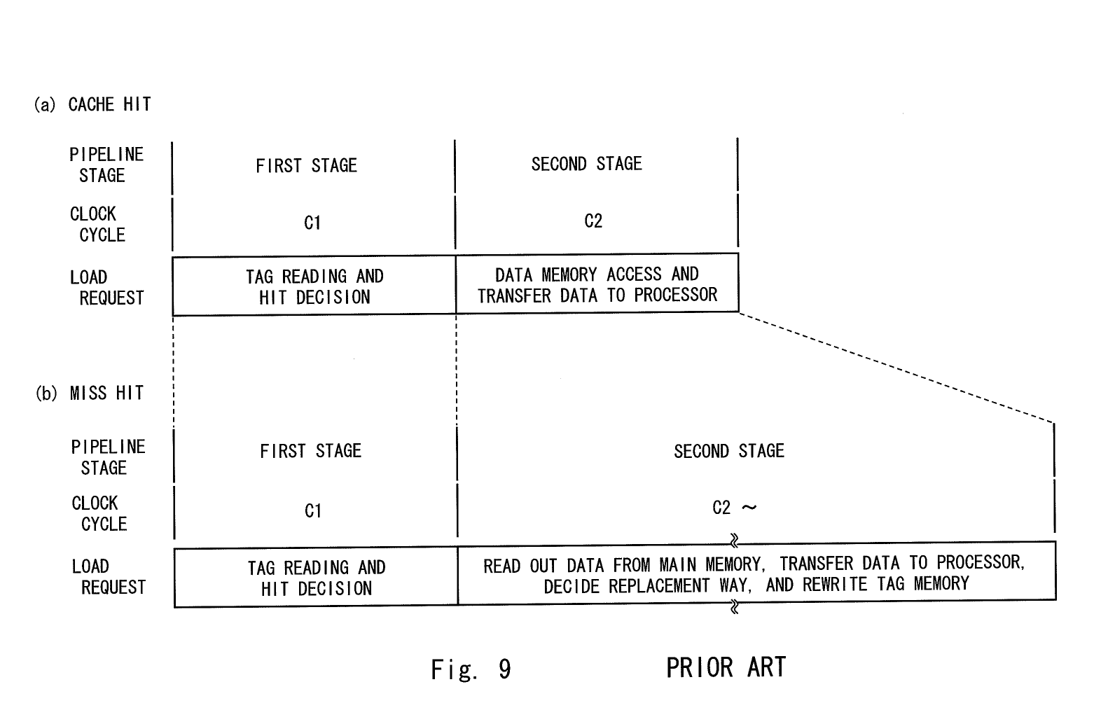

FIG. 3 is a diagram showing a pipeline processing by the cache memory according to the first exemplary embodiment of the present invention. As the operation in case of the cache hit shown in part (a) of FIG. 3 is similar to that of part (a) of FIG. 9, description thereof will be omitted.

In case of the miss hit and no subsequent memory access shown in part (b) of FIG. 3, the controller 13 decides whether there is a subsequent memory access at a second stage. It is assumed here that the controller 13 decides that there is no subsequent memory access. In this case, the controller 13 does not output the WAIT signal.

The controller 13 further controls the update processing of the tag memory and the update processing of the data memory. The controller 13 performs, for example, as the update processing of the tag memory, processing to determine the replacement way and processing to rewrite the tag memory 11 as is similar to part (b) of FIG. 9. The controller 13 further performs the update processing of the data memory. The update processing of the data memory is, for example, the processing of reading out data from the main memory 3 to store the data which is read out in the data memory 10 and the processing of outputting the data read out from the main memory 3 to the processor 2, as is similar to the part (b) of FIG. 9.

When it is decided as the miss hit and there is a subsequent memory access as shown in part (c) of FIG. 3, the controller 13 decides whether there is a subsequent memory access at the second stage. It is assumed here that the controller 13 decides that there is a subsequent memory access. The controller 13 then stalls the pipeline processing of the cache memory 1 and outputs the WAIT signal to the processor 2 at the second stage. Accordingly, the second stage continues in the clock cycle C2 and later. The controller 13 further controls the update processing of the tag memory and the update processing of the data memory at the second stage.

According to the first exemplary embodiment of the present invention, as will be understood from the above description, it is possible to reduce the occurrence of the WAIT signal to maintain the data consistency and to effectively process the subsequent memory access when there is no subsequent memory access in case of the miss hit.

The first exemplary embodiment of the present invention is especially effective as it is possible to simplify the decision processing of the presence or absence of the subsequent memory access when the frequency of the processor 2 is high.

### SECOND EXEMPLARY EMBODIMENT

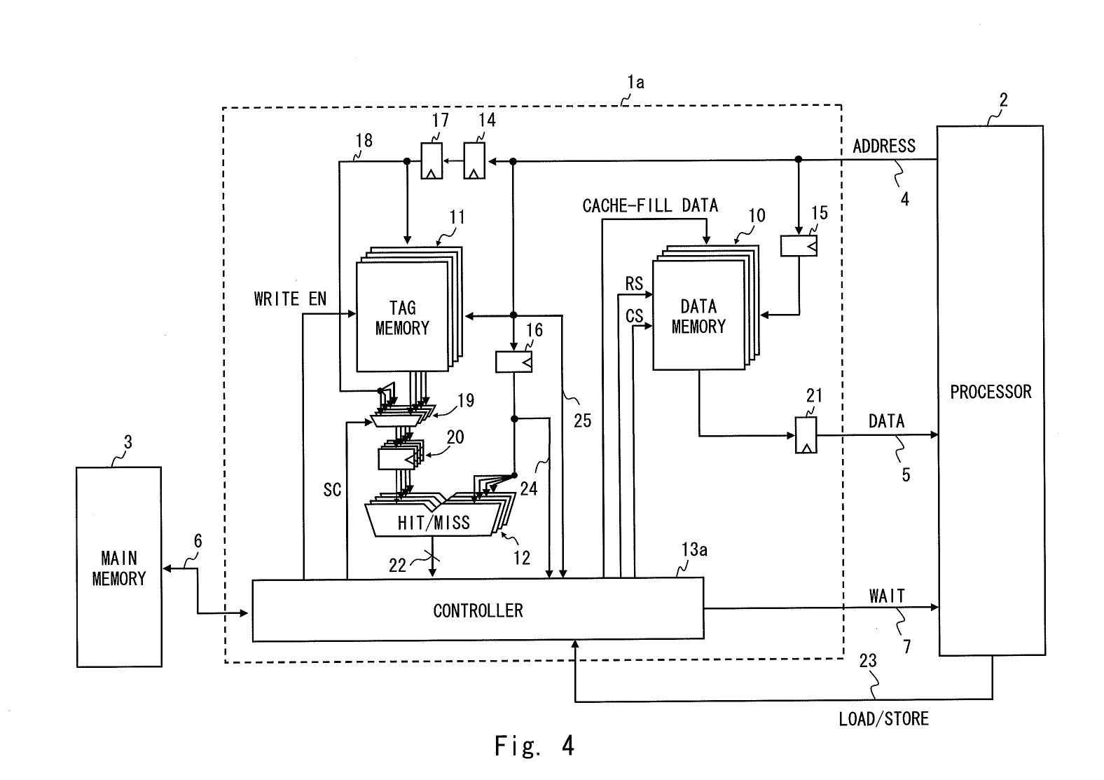

A cache memory according to the second exemplary embodiment of the present invention is obtained by improving the patent document 2 by applying the present invention to the patent document 2. FIG. 4 is a configuration diagram of a cache memory 1a according to the second exemplary embodiment of the present invention. Although the cache memory 1a according to the second exemplary embodiment of the present invention has a four-way set associative configuration, it is not limited to this example as is similar to the first exemplary embodiment of the present invention. Further, the components shown in FIG. 4 which are disclosed in the patent document 2 or which are similar to those shown in FIG. 1 are denoted by the same reference symbols, and the detailed description thereof will be omitted.

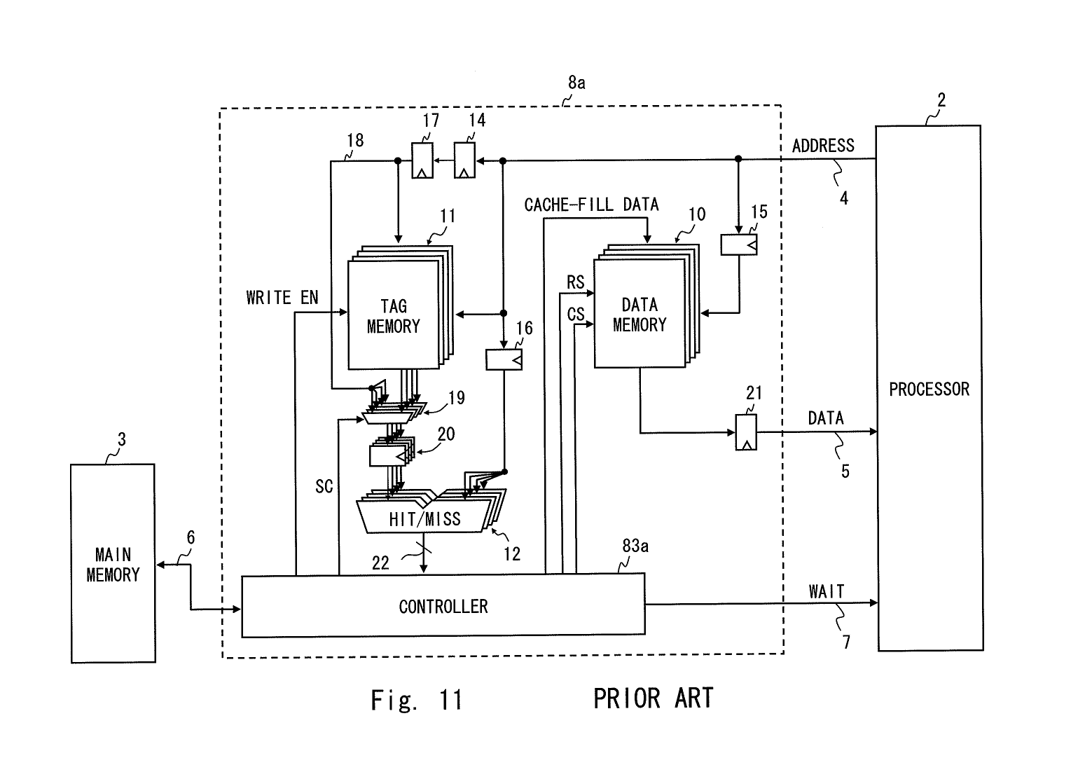

In FIG. 4, there is added the control signal line 23 which is similar to that in FIG. 1 according to the first exemplary embodiment of the present invention compared with FIG. 11.

Further, in the cache memory 1a, the address latch 16 and the controller 13a are connected by a first index address bus 24. Accordingly, the input address stored in the address latch 16 is input to both of the hit decision unit 12 and the controller 13a. Note that it is required that at least an index address of the input address stored in the address latch 16 be input to the controller 13a through the first index address bus 24.

Further, a second index address bus 25 extended from the address bus 4 is connected to the controller 13a. Note that it is required that at least an index address of the input address from the processor 2 be input to the controller 13a through the second index address bus 25.

Accordingly, the controller 13a is able to receive the first index address that corresponds to the memory access which is the processing target from the first index address bus 24 and receive the first index address that corresponds to the memory access that will be processed next to the memory access from the second index address bus 25.

Upon decision as the miss hit by the hit decision unit 12, the controller 13a decides whether the next memory access is one of the load instruction and the stores instruction as is similar to the controller 13 according to the first exemplary embodiment of the present invention. When it is decided that the next memory access is one of the load instruction and the store instruction, the controller 13a compares the first index address with the second index address, and decides whether at least a part of them is matched. After that, the controller 13a stalls the pipeline processing of the cache memory 1a and outputs the WAIT signal to the processor 2 when at least a part of them is matched. Further, the controller 13a does not output the WAIT signal and does not stall the pipeline processing of the cache memory 1a and the processor 2 when the next memory access is neither the load instruction nor the store instruction or when at least a part of the first index address and the second index address is not matched.

Accordingly, regardless of whether the subsequent memory access is one of the load instruction and the store instruction in case of the miss hit, the controller 13a does not output the WAIT signal to the processor 2 when the subsequent memory access request is the access to the memory block which is different from the previous memory access request in which the miss hit occurs. In summary, the cache memory 1a according to the second exemplary embodiment of the present invention is able to decide whether there is a subsequent memory access in a simple way. Accordingly, in this case, the pipeline processing of the cache memory 1a and the processor 2 is not stalled, and the subsequent processing can be advanced without delay.

Note that the controller 13a may also operate as follows when it is decided as the miss hit and the subsequent memory access is one of the load instruction and the store instruction. The controller 13a firstly decides whether the first index address and the second index address are completely matched. At this time, the controller 13a outputs the WAIT signal when they are completely matched. Further, the controller 13a may not output the WAIT signal when they are not completely matched. Accordingly, the output of the WAIT signal can be minimized, which realizes effective processing. This example is especially effective as the output of the WAIT signal can be minimized when the frequency clock number of the processor 2 is low.

Alternatively, the controller 13a may operate as follows when it is decided as the miss hit and the subsequent memory access is one of the load instruction and the store instruction. The controller 13a firstly compares the first index address with the second index address, and decides whether at least a part of them is matched. At this time, the controller 13a outputs the WAIT signal when at least a part of them is matched. Further, the controller 13a may not output the WAIT signal when they are not matched. For example, it may be the case in which each predetermined lower bit in the first index address and the second index address is matched with each other. Alternatively, any one-bit digit of each of the index addresses may be compared. Further, the number of bit digits to be compared may be adjusted as needed. Accordingly, the output of the WAIT signal can be suppressed compared with the first exemplary embodiment of the present invention, and the decision whether there is a subsequent memory access can be simplified compared with the case in which the WAIT signal is output when the two index addresses are completely matched as stated above. This example is especially effective when the frequency of the processor 2 is around the middle of the both cases.

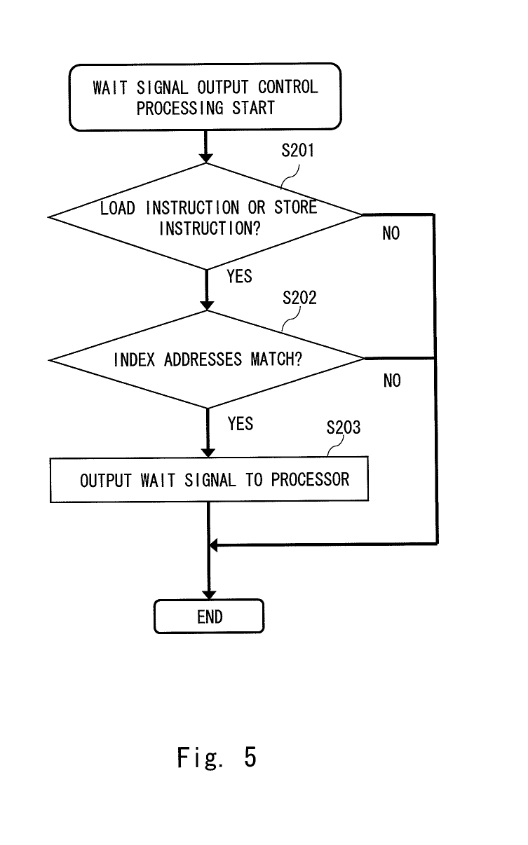

FIG. 5 is a flow chart showing WAIT signal output control processing in case of the miss hit according to the second exemplary embodiment of the present invention. First, in case of the miss hit, the controller 13a refers to the flag included in the control signal that corresponds to the next memory access of the memory access in which it is decided as the miss hit, and decides whether there is a subsequent memory access depending on whether the next memory access is one of the load instruction and the store instruction (S201).

When the next memory access is one of the load instruction and the store instruction, the controller 13a compares the first index address with the second index address, and decides if at least a part of them is matched (S202).

When at least a part of them is matched, the controller 13a performs the similar processing as step S102 of FIG. 2 (S203). Accordingly, the pipeline processing of the cache memory 1a and the processor 2 is stalled, and the processing for the subsequent memory access is performed for the tag memory 11 after being updated.

Further, when it is decided in step S201 that the next memory access is neither the load instruction nor the store instruction, or when it is decided in step S202 that the first index address does not match the second index address, the controller 13a does not stall the pipeline processing of the cache memory 1a and does not output the WAIT signal to the processor 2. Accordingly, the pipeline processing of the cache memory 1a and the processor 2 is not stalled, and the processing for the subsequent memory access is subsequently performed without waiting for the updating of the tag memory 11.

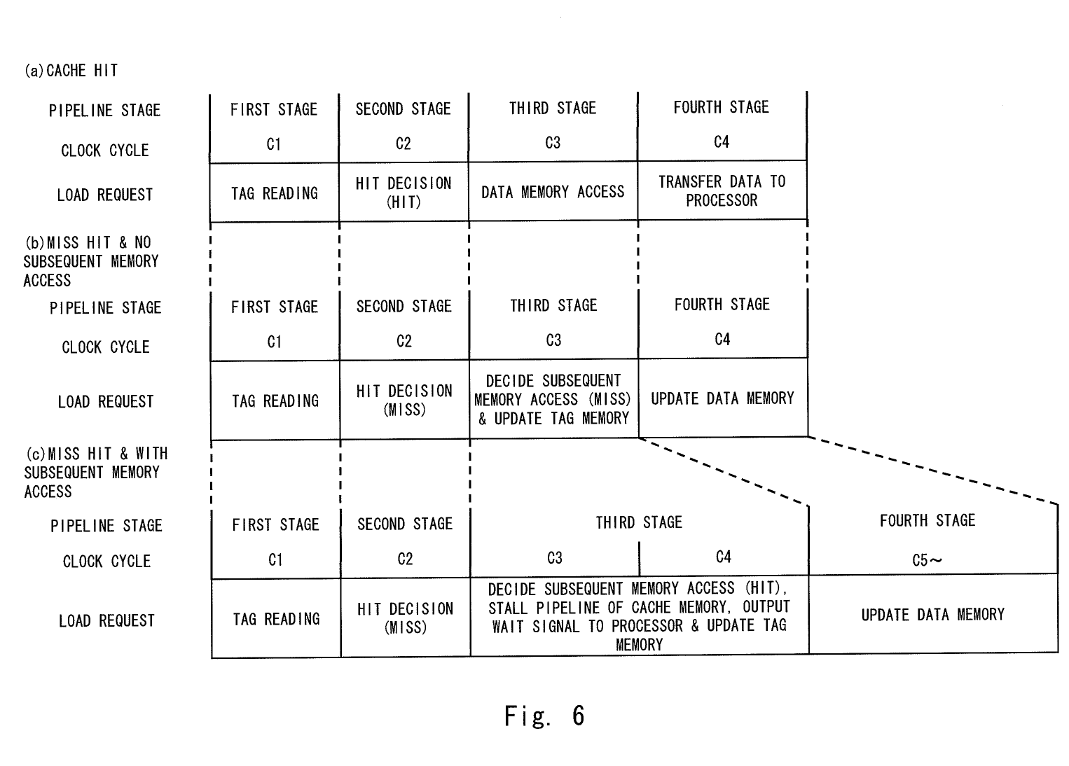

FIG. 6 is a diagram showing a pipeline processing by the cache memory 1a according to the second exemplary embodiment of the present invention. FIG. 6 is different from FIG. 3 in that it is the description of the four-stage processing. In summary, the controller 13a performs tag reading at the first stage and hit decision at the second stage. Further, the controller 13a executes a third stage and a fourth stage based on the result of the hit decision at the second stage. Note that the operation in case of the cache hit as shown in part (a) of FIG. 6 is similar to that as shown in part (a) of FIG. 2 of the patent document 2, and therefore, the description thereof will be omitted.

When it is decided as the miss hit and there is no subsequent memory access as shown in part (b) of FIG. 6, the controller 13a decides whether there is a subsequent memory access at the third stage. It is assumed here that the controller 13a decides that there is no subsequent memory access. In summary, the controller 13a does not output the WAIT signal at this time. Further, the controller 13a performs controlling of the update processing of the tag memory at the third stage and the update processing of the data memory at the fourth stage.

When it is decided as the miss hit and there is a subsequent memory access as shown in part (c) of FIG. 6, the controller 13a decides whether there is a subsequent memory access at the third stage. At this time, the controller 13a decides that there is a subsequent memory access. The controller 13a then stalls the pipeline processing of the cache memory 1a and outputs the WAIT signal to the processor 2 at the third stage. Accordingly, the third stage continues also in C4 which follows the clock cycle C3. Further, the controller 13a performs the controlling of the update processing of the tag memory at the third stage and the update processing of the data memory at the fourth stage.

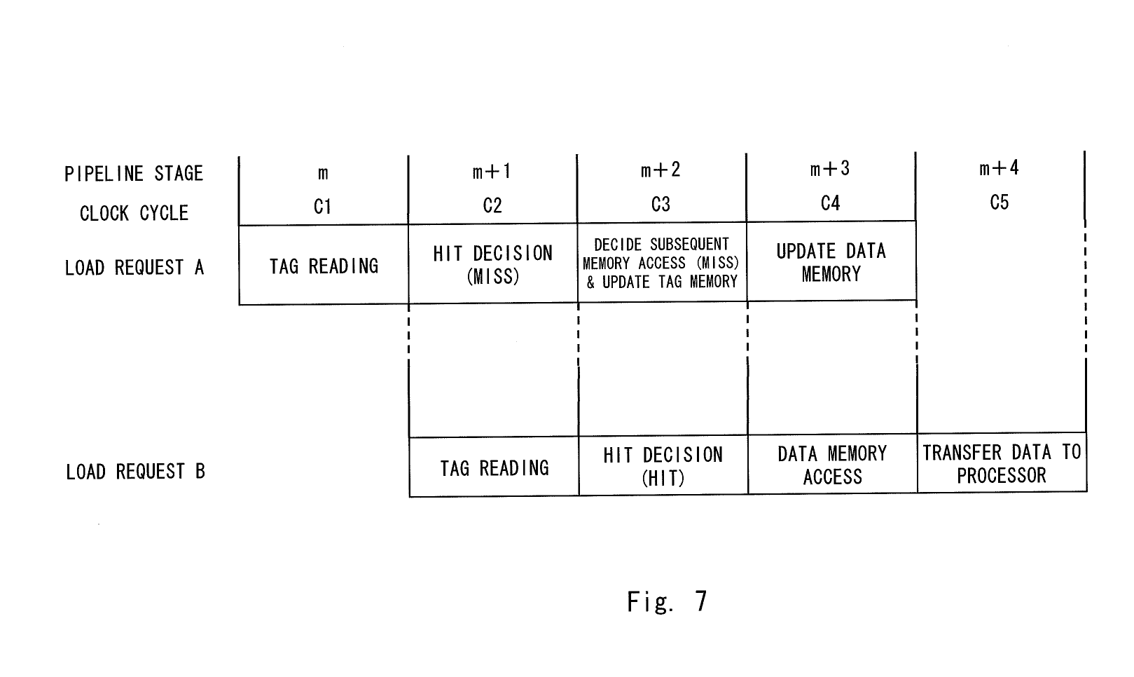

The effect of the cache memory 1a which operates as above will be described with reference to FIG. 7. FIG. 7 is a timing chart showing a pipeline processing of the cache memory 1a when two load requests (load requests A and B) are successively performed. More specifically, FIG. 7 shows a case in which the first index address and the second index address are not matched when the decision of the subsequent memory access is one of the load instruction and the store instruction upon occurrence of the miss hit in the preceding load request A.

As shown in FIG. 7, when the hit decision of the second stage ((m+1)th stage) of the load request A is the miss hit, it is decided at C3 cycle of the subsequent third stage ((m+2)th stage) that there is no subsequent memory access. Further, the tag memory is updated at the same C3 cycle. However, as the controller 13a does not output the WAIT signal to the processor 2, the pipeline is not stalled for one cycle.

In parallel with the processing for the load request A which has been described above, the processing for the subsequent load request B is started. More specifically, at (m+1)th stage, which is the second stage of the load request A, the tag address is read out from the tag memory 11 which is the processing of the first stage of the load request B. In other words, updating of the tag memory 11 according to the miss hit of the preceding load request A is not completed at a time when the tag address of the load request B is read out. However, in this example, the first index address accessed by the load request A and the second index address accessed by the load request B are different. Accordingly, the hit decision of the second stage ((m+2)th stage) of the load request B is the cache hit.

Then, at the subsequent third stage ((m+3)th stage) of the load request B, the data memory access is performed. In other words, the processing of the load request B is not influenced by the fact that the updating of the tag memory 11 in accordance with the miss hit of the preceding load request A has not been completed.

Note that, even when the hit decision at the second stage ((m+2)th stage) of the load request B is the miss hit, as it is the hit decision due to the second index address which is different from the first index address, the hit decision here is not false detection even though the update of the tag memory 11 along with the miss hit of the preceding load request A has not been completed.

According to the second exemplary embodiment of the present invention, in addition to the decision regarding whether the next memory access is one of the load instruction and the store instruction, the index addresses are compared upon occurrence of the miss hit. Accordingly, it can be decided whether there is a subsequent memory access with more detail. The occurrence of the WAIT signal can be minimized by outputting the WAIT signal only when the index addresses are completely matched. Further, the decision regarding whether there is a subsequent memory access can be effectively performed by comparing a part of the index addresses instead of comparing the whole part of the index addresses.

### ANOTHER EXEMPLARY EMBODIMENT

Note that the condition to determine that there is a subsequent memory access in the first exemplary embodiment of the present invention is not limited to the case in which the next memory access is one of the load instruction and the store instruction. For example, even in the first exemplary embodiment of the present invention, the index addresses may be compared as shown in the second exemplary embodiment of the present invention. Accordingly, it can be decided whether there is a subsequent memory access with more accuracy. Alternatively, the decision processing of steps S201 and S202 of FIG. 5 may be applied to the cache memory 1 according to the first exemplary embodiment of the present invention. Accordingly, it can be decided whether there is a subsequent memory access with more efficiency.

Note that, in the present invention, it is also possible to not to make a decision regarding whether the next memory access is one of the load instruction and the store instruction for deciding whether there is a subsequent memory access in the second exemplary embodiment of the present invention. In this case, only the comparison of the index addresses is performed. In such a case, the step 5201 of FIG. 5 may not be performed. Accordingly, it is not needed to decide the flag included in the control signal input through the control signal line 23, which can simplify decision regarding whether there is a subsequent memory access.

Needless to say, the present invention is not limited to the above described exemplary embodiments, but can be changed in various ways without departing from the scope of the present invention which has already been stated.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A cache memory arranged between a processor and a low-speed memory and performing a pipeline processing of a memory access made by the processor, comprising:
a data memory being configured to store data corresponding to a subset of the low-speed memory;
a tag memory being configured to store tag addresses corresponding to the data stored in the data memory;
a hit decision unit being configured to decide whether there is a cache hit or a miss hit by comparing at least one tag address acquired by searching the tag memory using a first index address included in an input address supplied from the processor with a tag address included in the input address; and
a controller that performs update processing of the tag memory and the data memory and decides whether or not there is a subsequent memory access upon decision by the hit decision unit that the input address is the miss hit, the controller outputting a WAIT signal for generating a pipeline stall for the pipeline processing of the processor to the processor upon decision that there is the subsequent memory access, while the controller not outputting the WAIT signal upon decision that there is no subsequent memory access.

2. The cache memory according to claim 1, wherein the controller compares the first index address with a second index address, the second index address being included in an input address in the subsequent memory access, the controller deciding that there is the subsequent memory access when at least a part of the first index address and the second index address is matched.

3. The cache memory according to claim 1, wherein the controller decides that there is the subsequent memory access when the subsequent memory access is one of a load instruction and a store instruction.

4. The cache memory according to claim 2, wherein the controller decides that there is the subsequent memory access when the subsequent memory access is one of a load instruction and a store instruction.

5. The cache memory according to claim 1, wherein the controller decides whether or not the subsequent memory access is one of a load instruction and a store instruction, the controller comparing the first index address with a second index address to decide whether a part of the first index address and the second index address is matched upon decision as one of the load instruction and the store instruction, the second index address being included in an input address in the subsequent memory access, and the controller decides that there is the subsequent memory access when at least a part of the first index address and the second index address is matched.

6. The cache memory according to claim 2, wherein the controller decides whether or not the subsequent memory access is one of a load instruction and a store instruction, the controller comparing the first index address with a second index address to decide whether a part of the first index address and the second index address is matched upon decision as one of the load instruction and the store instruction, the second index address being included in an input address in the subsequent memory access, and the controller decides that there is the subsequent memory access when at least a part of the first index address and the second index address is matched.

7. The cache memory according to claim 2, wherein the controller decides that there is the subsequent memory access when a predetermined lower bit in the first index address and a predetermined lower bit in the second index address are matched.

8. The cache memory according to claim 5, wherein the controller decides that there is the subsequent memory access when a predetermined lower bit in the first index address and a predetermined lower bit in the second index address are matched.

9. The cache memory according to claim 6, wherein the controller decides that there is the subsequent memory access when a predetermined lower bit in the first index address and a predetermined lower bit in the second index address are matched.

10. A method of controlling a cache memory arranged between a processor and a low-speed memory and performing a pipeline processing of a memory access made by the processor, wherein
the cache memory comprises:
a data memory being configured to store data corresponding to a subset of the low-speed memory; and
a tag memory being configured to store tag addresses corresponding to the data stored in the data memory, the method comprising:
searching one tag address from the tag memory using a first index address included in an input address supplied from the processor;
deciding whether there is a cache hit or a miss hit by comparing at least one tag address acquired by searching the tag memory with a tag address included in the input address;
updating the tag memory and the data memory upon decision that the input address is the miss hit; and
deciding whether there is a subsequent memory access upon decision as the miss hit, outputting a WAIT signal for generating a pipeline stall for the pipeline processing of the processor to the processor upon decision that there is the subsequent memory access, while not outputting the WAIT signal upon decision that there is no subsequent memory access.

11. The method according to claim 10, comprising comparing the first index address with a second index address, the second index address being included in an input address in the subsequent memory access, and deciding that there is the subsequent memory access when at least a part of the first index address and the second index address is matched.

12. The method according to claim 10, comprising deciding that there is the subsequent memory access when the subsequent memory access is one of a load instruction and a store instruction.

13. The method according to claim 11, comprising deciding that there is the subsequent memory access when the subsequent memory access is one of a load instruction and a store instruction.

14. The method according to claim 10, comprising deciding whether or not the subsequent memory access is one of a load instruction and a store instruction, comparing the first index address with a second index address to decide whether a part of the first index address and the second index address is matched when the subsequent memory access is one of the load instruction and the store instruction, the second index address being included in an input address in the subsequent memory access, and deciding that there is the subsequent memory access when at least a part of the first index address and the second index address is matched.

15. The method according to claim 11, comprising deciding whether or not the subsequent memory access is one of a load instruction and a store instruction, comparing the first index address with a second index address to decide whether a part of the first index address and the second index address is matched when the subsequent memory access is one of the load instruction and the store instruction, the second index address being included in an input address in the subsequent memory access, and deciding that there is the subsequent memory access when at least a part of the first index address and the second index address is matched.

16. The method according to claim 11, comprising deciding that there is the subsequent memory access when a predetermined lower bit in the first index address and a predetermined lower bit in the second index address are matched.

17. The method according to claim 14, comprising deciding that there is the subsequent memory access when a predetermined lower bit in the first index address and a predetermined lower bit in the second index address are matched.

18. The method according to claim 15, comprising deciding that there is the subsequent memory access when a predetermined lower bit in the first index address and a predetermined lower bit in the second index address are matched.
